(19) United States
(12) Patent Application Publication
(10) Pub. No.: US 2008/0123030 A1
(43) Pub. Date: May 29, 2008

(54) LIQUID CRYSTAL DISPLAY DEVICE

(76) Inventor: Sung Hun SONG, Beijing (CN)

Correspondence Address: HASSE & NESBITT LLC, 8837 CHAPEL SQUARE DRIVE, SUITE C, CINCINNATI, OH, 45249, US

(21) Appl. No.: 11/947,099

(22) Filed: Nov. 29, 2007

(30) Foreign Application Priority Data
Nov. 29, 2006 (CN) CN 200610144201.4

(51) Int. Cl. G02F 1/1339

(52) U.S. Cl. 349/110

(57) ABSTRACT

A liquid crystal display (LCD) device, having post spacers on the black matrix that are disposed at both sides of the horizontal or longitudinal lines at the intersections of the horizontal lines with longitudinal lines of the black matrix on the color filter substrate, and that are disposed at both sides of the data scanning lines at the intersections of the data scanning lies with the gate scanning lines on TFT array substrate.

### BACKGROUND OF THE INVENTION

The present invention relates to a liquid crystal display (LCD) device.

LCD devices have been widely employed as the monitor for a desktop computer, a notebook computer, or a TV set, and are in high definition and capable of full-color displaying. A LCD device basically comprises a pair of opposite substrates and a liquid crystal layer interposed therebetween. The pair of substrates comprises a color filter substrate and a thin film transistor (TFT) array substrate opposing to each other, and the liquid crystal layer is encapsulated between the color filter substrate and the TFT array substrate. In the LCD device, the display of images is realized by controlling the transmittance of the light passing through the liquid crystal layer with a voltage applied across the substrates.

The TFT array substrate usually comprises a glass substrate and a TFT array structure fabricated thereon. The array structure comprises a plurality of gate scanning lines and a plurality of data scanning lines, and the neighboring gate scanning lines and data scanning lines cross with each other to define a plurality of pixel areas. Each pixel area comprises the constituent parts such as a TFT, a common electrode, and a pixel electrode. The color filter substrate is usually provided with a black matrix, a color filter, an opposing electrode, and the like. The spacing between the color filter substrate and the TFT array substrate, i.e., the cell gap, is maintained at a specified value to sandwich the liquid crystal layer therebetween. As a means to maintain the gap, small particles (spherical spacer) of glass or resin are conventionally utilized. Spherical spacers are dispersed onto one of the substrate before assembling the substrates, and thus the spherical spacers may be dispersed in the pixel areas, which may result in light leakage. The transmitted or reflected light passes through the spherical spacers in the pixel areas, resulting in degradation of contrast.

To resolve the above-mentioned problem in connection with the spherical spacers, post members are fixedly formed as spacers outside the pixel area in the related art, and these spacers are so-called post spacers. The post spacers can be formed by laminating color filters of various colors and light-shielding layers into post shape, formed by laminating color filters into post shape at the terminal portion, or formed of a photosensitive resist via a photolithography process, on the surface of the color filter substrate on which no metal lines such as the gate lines and the TFT are provided.

FIG. 1 is a partial top view showing a color filter substrate in the related art; FIG. 2 is a partial top view showing a TFT array substrate in the related art; FIG. 3 is a cross-sectional view taken along the line a-a in FIG. 1, showing the color filter substrate and the TFT substrates assembled together in the related art; and FIG. 4 is a cross-sectional view taken along the line b-b in FIG. 1, showing the color filter substrate and the TFT substrates assembled together in the related art.

As shown in the above figures, the color filter substrate 10 comprises an upper glass substrate 1, and a black matrix 2, a color resin 3, and post spacers 4 formed on the upper glass substrate 1; the TFT array substrate 20 comprises a lower glass substrate 6, and gate scanning lines 7 and data scanning lines 8 formed on the lower glass substrate 6. The neighboring gate scanning lines 7 and data scanning lines 8 cross with each other to define pixel areas P arranged in a matrix. Each pixel area P further comprises a TFT as a switching element and a pixel electrode (not shown) connected with the TFT. The gate scanning lines 7 are further covered by a gate scanning line protection layer 5. In general, post spacers 4 are provided corresponding to the pixel area in a one-to-one relationship across the LCD. In addition, after assembling the substrates, the post spacers 4 overlap with the gate scanning lines 7 on the TFT array substrate 20 and are engaged with post spacer engagement parts 9 on the TFT array substrate 20.

In the LCD device in the related art, the force of the post spacers 4 to secure the upper and lower substrates only exists in the up-down direction, so the upper and lower substrates can only be secured by the force in the up-down direction. If there is not external force exerted in the up-down direction, there will be no misalignment between the upper and lower substrates. However, if there is exerted an external force and the post spacers will be subject to a force in the horizontal direction, so there will be misalignment between the upper and lower substrates, which may degrade the image quality.

### SUMMARY OF THE INVENTION

In view of the problem of the related art, the present invention is conceived to overcome the problem by providing a LCD device with post spacers.

In one aspect of the invention, there is provided a LCD device. The LCD device comprises a color filter substrate and a TFT array substrate which are arranged oppositely, in confronting relation, to each other, and a liquid crystal layer encapsulated between the color filter substrate and the TFT array substrate. The color filter substrate comprises an upper substrate, a black matrix and post spacers formed on the black matrix. The TFT array substrate comprises a lower substrate, and gate scanning lines and data scanning lines formed on the lower substrate, and the neighboring gate scanning lines and data scanning lines cross with each other to define pixel areas. The post spacers on the black matrix are disposed at both sides of the horizontal or longitudinal lines at the intersections of the horizontal lines with longitudinal lines of the black matrix. The post spacers are also disposed at both sides of the data scanning lines at the intersections of the data scanning lies with the gate scanning lines.

In a preferred embodiment, the post spacers on the black matrix are disposed at both sides of the horizontal or longitudinal lines at some or all of the intersections of the horizontal lines with longitudinal lines of the black matrix, and the post spacers can be arranged at both sides the data scanning lines at some or all of the intersections of the data scanning lines with the gate scanning lines.

In a preferred embodiment, the distances between the centers of the cross-section of the post spacers and the respective edges of the corresponding data scanning line may be 10 μm or less, and the distances may be of the same or different from each other. The cross-section of the post spacer perpendicular to the surface of substrate may be in a trapezoid shape, and the end of the post spacer disposed on the color filter substrate is wider than that disposed on the TFT array substrate.

In a preferred embodiment, the post spacers on the black matrix can further comprise post spacers disposed at other positions at both sides of the horizontal or longitudinal lines at the intersections of the horizontal lines with longitudinal lines of the black matrix, and disposed at other positions at both sides the data scanning lines at the intersections of the data scanning lines with the gate scanning lines.

Compared with the related art, in the embodiment of the present invention, since the structure of the post spacers is improved, the post spacers will not substantially displace even in case of impact of external force, so that the accuracy of alignment of the upper and lower substrates can be improved without decreasing the transmittance, and the image quality and the efficiency of manufacturing process can also be increased.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a partial top view showing a color filter substrate in the related art.

FIG. 2 is a partial top view showing a TFT array substrate in the related art.

FIG. 3 is a cross-sectional view taken along the line a-a in FIG. 1, showing the color filter substrate and the TFT substrates assembled together in the related art.

FIG. 4 is a cross-sectional view taken along the line b-b in FIG. 1, showing the color filter substrate and the TFT substrates assembled together in the related art.

FIG. 5 is a partial top view showing a color filter substrate according to an embodiment of the present invention.

FIG. 6 is a partial top view showing a TFT array substrate according to an embodiment of the present invention.

FIG. 7 is a cross-sectional view taken along the line c-c in FIG. 5, showing the color filter substrate and the TFT substrates assembled together according to the embodiment of the present invention.

FIG. 8 is a cross-sectional view taken along the line d-d in FIG. 5, showing the color filter substrate and the TFT substrates assembled together according to the embodiment of the present invention.

FIG. 9 is a schematic diagram showing the distances between the post spacers and the data scanning lines according to the embodiment of the present invention.

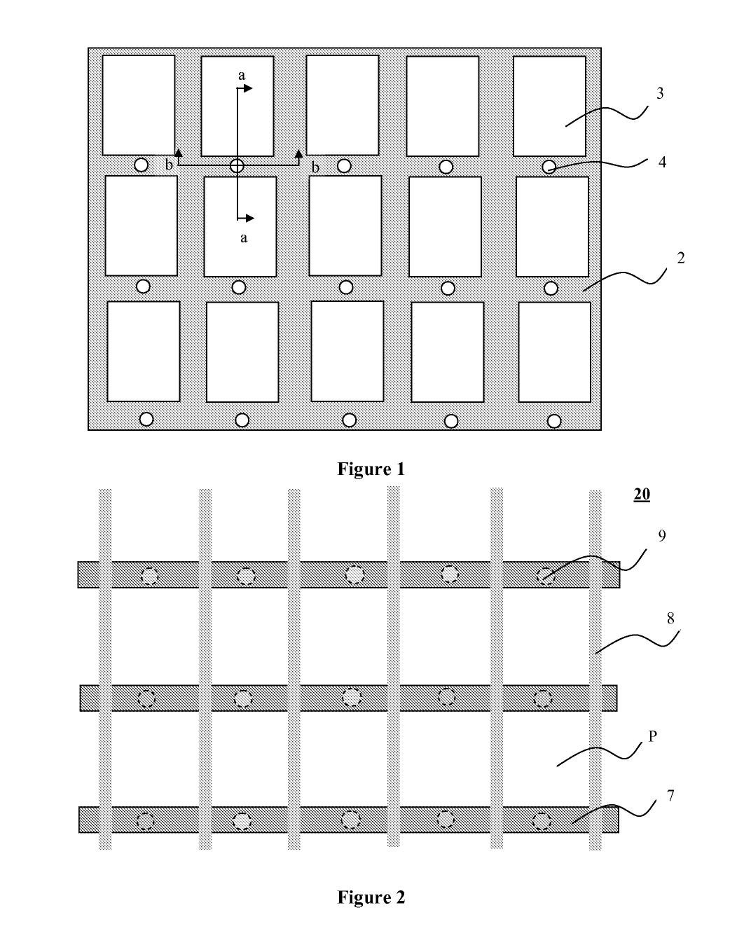

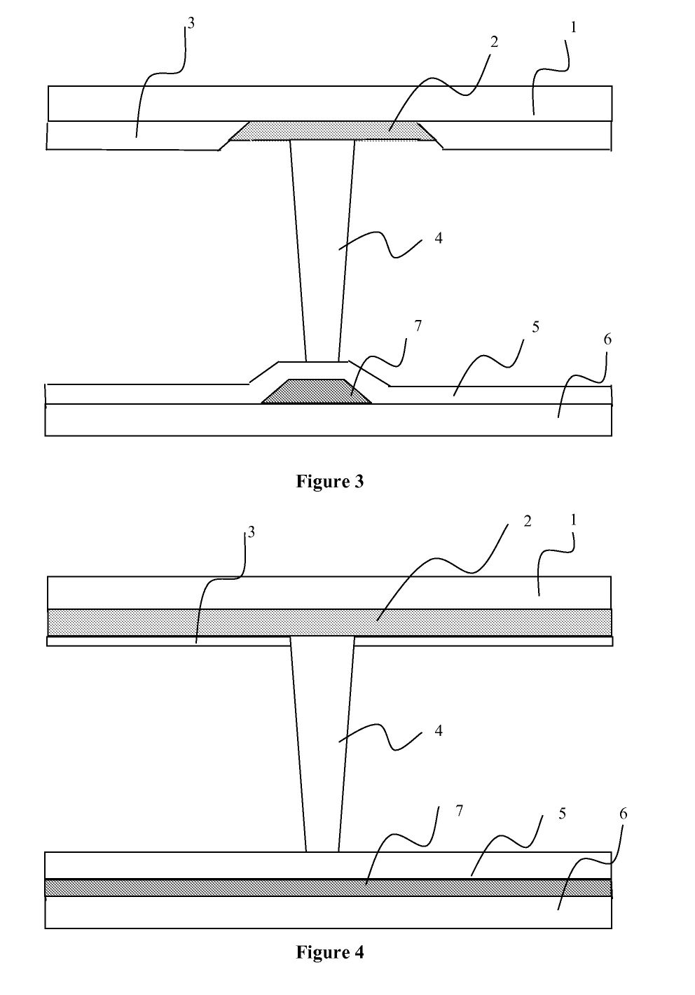

### DETAILED DESCRIPTION OF THE INVENTION

The exemplary embodiments according to the present invention will be described in detail with reference to the accompanying drawings. This invention may, however, be embodied in many different forms and should not be construed as limited to the embodiments set forth hereinafter. In the context, it will be understood by those skilled in the art that when an element or a layer is referred to as being “on” or “connected to” another element or layer, it can be directly on or connected to the other element or layer, or intervening elements or layers may be present. Also, the directions referred to “longitudinal” or “horizontal” are relative, and it will be understood that if a figure is rotated by 90 degrees, the “longitudinal” or “horizontal” directions are interchanged.

In an embodiment of the present invention, there is provided a LCD device with an improved structure connected with post spacers. The LCD device comprises a color filter substrate and a TFT array substrate opposing to each other, and a liquid crystal layer is encapsulated between the color filter substrate and the TFT array substrate. In the LCD device, the display of images is realized by controlling the transmittance of the light passing through the liquid crystal layer with a voltage applied across the substrates.

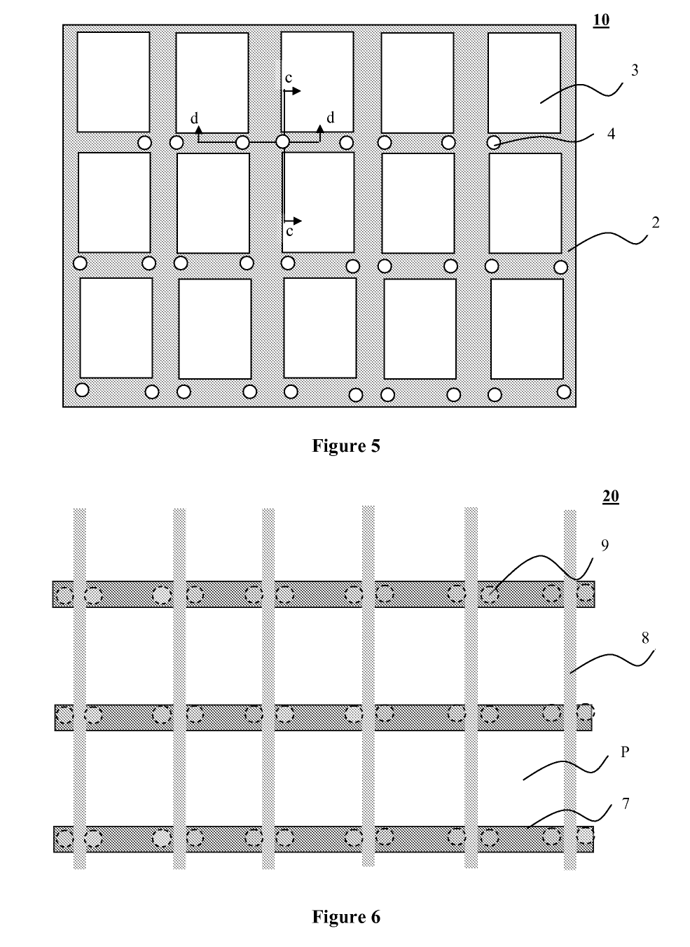

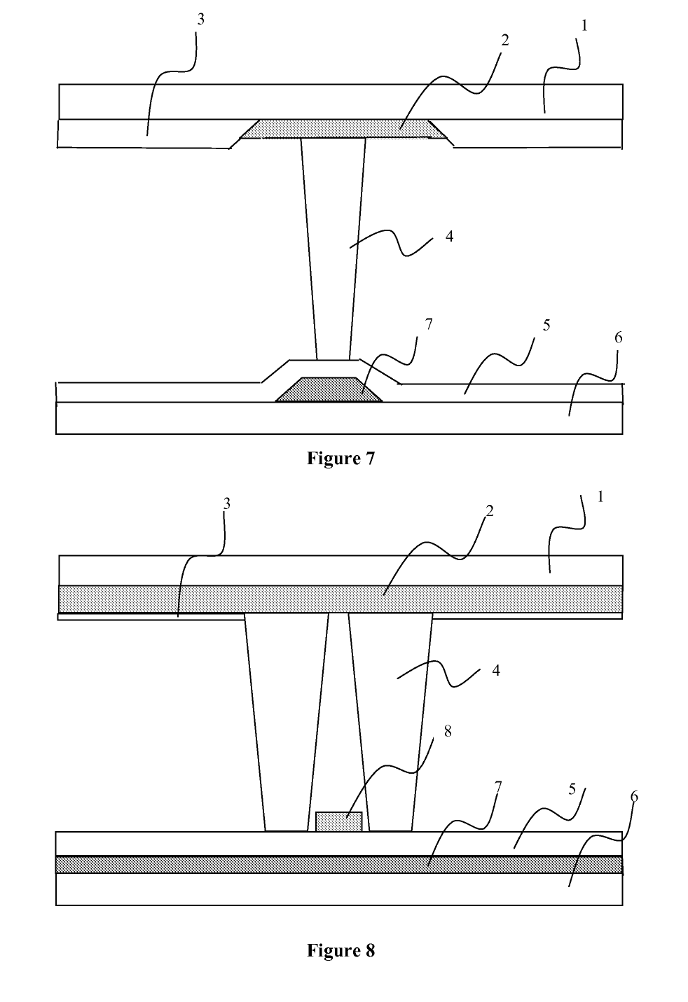

FIG. 5 is a partial top view showing a color filter substrate according to an embodiment of the present invention. FIG. 6 is a partial top view showing the TFT array substrate according to an embodiment of the present invention. FIG. 7 is a cross-sectional view taken along the line c-c in FIG. 5, showing the color filter substrate and the TFT substrates assembled together according to an embodiment of the present invention. FIG. 8 is a cross-sectional view taken along the line d-d in FIG. 5, showing the color filter substrate and the TFT substrates assembled together according to an embodiment of the present invention.

As shown in FIGS. 5-8, in the embodiment of the present invention, the color filter substrate 10 comprises an upper glass substrate 1, a black matrix 2 and a color resin 3 formed on the upper glass substrate 1, and post spacers 4 formed on the black matrix 2. The TFT array substrate 20 comprises a lower glass substrate 6, and a plurality of gate scanning lines 7 and data scanning lines 8 formed on the lower glass substrate 6. The neighboring gate scanning lines 7 and data scanning lines 8 cross with each other to define pixel areas P arranged in a matrix. Each pixel area P comprises a TFT as a switching element and a pixel electrode (not shown) connected with the TFT. These constituent parts are similar to those in the related art. The black matrix 2 is formed between the color resins 3 on the glass substrate 1, and forms a plurality of matrix regions corresponding to the pixel areas formed on the TFT array substrate 20. In addition, an opposing electrode (not shown) is formed on the color filter substrate 10 and cooperates with the pixel electrode on the TFT array substrate to apply a voltage across the liquid crystal layer to change its transmittance.

In the embodiment of the present invention, the post spacers 4 are distributed unevenly on the black matrix 2 of the color filter substrate 10. For example, as shown in FIG. 5, the post spacers 4 are mainly distributed along the horizontal lines of the black matrix 2, and are disposed at both sides of the longitudinal lines at the intersections of the horizontal lines with longitudinal lines of the black matrix 2. Further, the positions of the post spacers 4 can be changed with the positions of the gate scanning lines and data scanning lines on the TFT array substrate 20, and can be distributed along the longitudinal lines of the black matrix 2 and disposed at both sides of the horizontal lines at the intersections of the longitudinal lines with horizontal lines. Once the color filter substrate 10 in FIG. 5 and the TFT array substrate 20 in FIG. 6 are assembled together, the data scanning lines 8 are disposed between a pair of post spacers 4 at the intersections of the data scanning lines 8 with the gate scanning lines 7, and the post spacers 4 are engaged with the post engagement parts 9 on the TFT array substrate 20.

Once the substrates 10 and 20 are assembled with each other, the post spacers 4 is elastic and may be subject to a permanent change in height when applied with an external force. As shown in FIG. 7 and FIG. 8, two post spacers 4 are disposed at both sides of one data scanning line 8. The cross-section of the post spacer 4 perpendicular to the surface of substrate may be in the shape of a trapezoid, and the top end (the end engaging with the TFT array substrate 20) is narrower than the bottom end (the end connected with the color filter substrate 10).

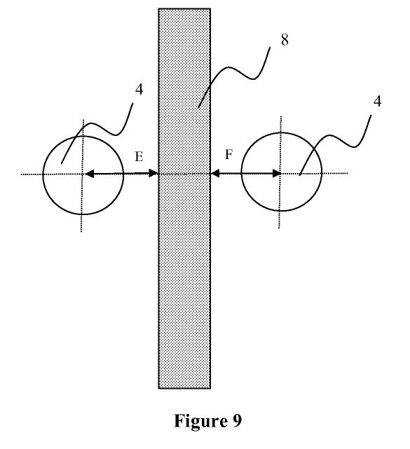

FIG. 9 is a schematic diagram showing the positional relationship between the post spacers 4 and the data scanning lines 8 according to embodiment of the present invention. As shown in FIG. 9, the post spacers 4 are disposed at both sides of the data scanning lines 8, and the distances between the centers of the cross-sections of the post spacers 4 and the respective edges of the corresponding data scanning lines 8 are “E” and “F,” respectively. Both of the distances E and F are equal to or less than 10 μm, and these distances may be of the same or different from each other. In FIG. 9, the cross-section of the post spacer 4 in a plane parallel with the substrate surface can be a circle, and can also be a triangle, a rectangle, and the like.

In addition, in the embodiment of the present invention, the post spacers 4 can be disposed at all of the intersections of the data scanning lines 8 with the gate scanning lines 7, and can also be disposed at some of the intersections of the data scanning lines 8 with the gate scanning lines 7. Furthermore, the post spacers 4 can be disposed in connection with post spacers in other structures or at other positions, and these other positions for example can be midway of the gate scanning lines 7 between the intersections with the data scanning lines 8.

The embodiment of the present invention overcomes the problems in the related art. That is, when the liquid crystal panel is impacted by an external force, since a pair of post spacers 4 are disposed at both sides of the data scanning lines 8, the post spacers are resisted by the data scanning lines 8 and prevented from displacing in the horizontal direction, so that there will be no inaccurate alignment between the upper and lower substrates due to the displacement of the post spacers.

It should be appreciated that the embodiments described above are intended to illustrate but not limit the present invention. Although the present invention has been described in detail herein with reference to the preferred embodiments, it should be understood by those skilled in the art that the present invention can be realized with different material and equipment as necessary, and that various modification and equivalents thereof can be made herein without departing from the spirit and scope of the present invention.

What is claimed is:

1. A liquid crystal display (LCD) device, comprising:
a color filter substrate
a thin film transistor (TFT) array substrate which are arranged oppositely to each other, and
a liquid crystal layer encapsulated between the color filter substrate and the TFT array substrate,
wherein the color filter substrate comprises an upper substrate, a black matrix and post spacers formed on the black matrix;
wherein the TFT array substrate comprises a lower substrate, and gate scanning lines and data scanning lines formed on the lower substrate, and neighboring gate scanning lines and data scanning lines cross with each other to define pixel areas; and
wherein the post spacers on the black matrix are disposed at both sides of the horizontal or longitudinal lines at intersections of the horizontal lines with the longitudinal lines of the black matrix, and the post spacers are disposed at both sides of the data scanning lines at intersections of the data scanning lies with the gate scanning lines.

2. The LCD device according to claim 1, wherein the post spacers on the black matrix are disposed at both sides of the horizontal or longitudinal lines at some of the intersections of the horizontal lines with longitudinal lines of the black matrix, and the post spacers are disposed at both sides the data scanning lines at some of the intersections of the data scanning lines with the gate scanning lines.

3. The LCD device according to claim 1, wherein the post spacers on the black matrix are disposed at both sides of the horizontal or longitudinal lines at all of the intersections of the horizontal lines with longitudinal lines of the black matrix, and the post spacers are disposed at both sides the data scanning lines at all of the intersections of the data scanning lines with the gate scanning lines.

4. The LCD device according to claim 1, wherein the distances between the centers of the cross-section of the post spacers at both sides of the data scanning line and the respective edges of the corresponding data scanning line are not larger than 10 μm.

5. The LCD device according to claim 1, wherein the distances between the centers of the cross-section of the post spacers at both sides of the data scanning line and the respective edges of the corresponding data scanning line are of the same.

6. The LCD device according to claim 1, wherein the distances between the centers of the cross-section of the post spacers at both sides of the data scanning line and the respective edges of the corresponding data scanning line are different from each other.

7. The LCD device according to claim 1, wherein the cross-section of the post spacer perpendicular to the surface of substrate is in a trapezoid shape, and the end of the post spacer on the color filter substrate is wider than that on the TFT array substrate.

8. The LCD device according to claim 1, wherein the post spacers on the black matrix further comprises post spacers disposed at other positions at both sides of the horizontal or longitudinal lines at the intersections of the horizontal lines with longitudinal lines of the black matrix, and disposed at other positions at both sides the data scanning lines at the intersections of the data scanning lines with the gate scanning lines.
